(19) United States
(12) Patent Application Publication
(10) Pub. No.: US 2013/0282763 A1
(43) Pub. Date: Oct. 24, 2013

(54) DATA PACKAGE FORMAT LIBRARY

(71) Applicant: ABB TECHNOLOGY AG., Zurich (CH)

(72) Inventors: KEVIN DALE STARR, Lancaster, OH (US); TIMOTHY ANDREW MAST, Plain City, OH (US)

(73) Assignee: ABB TECHNOLOGY AG., Zurich (CH)

(21) Appl. No.: 13/747,744

(22) Filed: Jan. 23, 2013

Related U.S. Application Data
(60) Provisional application No. 61/636,966, filed on Apr. 23, 2012.

(51) Int. Cl. G06F 17/30

(52) U.S. Cl. CPC G06F 17/30005
USPC 707/792

(57) ABSTRACT

A data package format library is provided to load, create and manipulate data from a plurality of different data formats into a format of a data package object. The data package object is a base object that represents a collection of information comprising time series data, equipment models, events, and relates the application-specific information to the time series data. Accordingly, strongly typed time series information from a data input received in one of the plurality of different data formats via an interface of the data package format library is stored in the data package object format. Time stamp data for each data point in another of the different data formats, and scalar and vector time series information in still another of the different data formats, are each received via respective interfaces of the data package format library and stored into the computer-readable storage medium in the data package object format.

### CROSS-REFERENCE TO RELATED APPLICATION

This application is a continuation, and claims priority, of a U.S. provisional patent application by Starr et al for DATA PACKAGE FORMAT LIBRARY, filed in the U.S. Patent and Trademark Office on May 23, 2012 and assigned Ser. No. 61/636,966, confirmation number 5096.

### TECHNICAL FIELD OF THE INVENTION

Embodiments of the present invention relate to data format libraries for loading, creating and manipulating data in respective data formats.

### BACKGROUND

Raw data from the field can come in a variety of formats. In order for various service tools to be able to handle these formats, one of two approaches can be adopted. The first is to allow all service tools to import from the full set of known formats. This presents a maintenance issue when trying to add a new format. The second approach is to first convert all the known file formats into a common file format. This allows the service tools to be written against the known format and allows the parsing code for the other file formats to be collected in one place.

This second approach has been widely adopted in service tools. Formats such as .pim, .pam, .pac, .ads and .tsd have all served as the lingua franca of the service tools. Each successive generation of file format has built on the previous generation in terms of capabilities and supported file formats.

### BRIEF SUMMARY

In one embodiment, a system has a processing unit, computer readable memory and a tangible computer-readable storage medium with program instructions, wherein the processing unit, when executing the stored program instructions, provides a data package format library to load, create and manipulate data from a plurality of different data formats into a format of a data package object. The data package object is a base object that represents a collection of information comprising time series data, equipment models, events, and relates the application-specific information to the time series data. Accordingly, the processing unit stores strongly typed time series information from a data input received in one of the plurality of different data formats via an interface of the data package format library into the computer-readable storage medium in the data package object format. It further receives, via respective interfaces of the data package format library, and stores into the computer-readable storage medium in the data package object format, each of time stamp data for each data point in another of the different data formats, and scalar and vector time series information in still another of the different data formats.

In another embodiment, an article of manufacture has a tangible computer-readable storage medium with computer readable program code embodied therewith, the computer readable program code comprising instructions that, when executed by a computer processing unit, cause the computer processing unit to provide a data package format library to load, create and manipulate data from a plurality of different data formats in a data package format of the data package format library. The processing unit thereby: stores strongly typed time series information; stores time stamp data for each data point; stores both scalar and vector time series; stores meta-data about information in the package; stores application-specific information; defines types of equipment that can be consumed by client applications; stores definitions and instances of equipment types; and stores equipment model information independent of the stored application-specific information.

In another embodiment of the present invention, a method provides a data package format library to load, create and manipulate data from a plurality of different data formats into a format of a data package object. The data package object is a base object that represents a collection of information comprising time series data, equipment models, events, and relates the application-specific information to the time series data. Accordingly, strongly typed time series information from a data input received in one of the plurality of different data formats via an interface of the data package format library is stored into a computer-readable storage medium in the data package object format. Further time stamp data for each data point in another of the different data formats, and scalar and vector time series information in still another of the different data formats are each received via respective interfaces of the data package format library and stored into the computer-readable storage medium in the data package object format.

### BRIEF DESCRIPTION OF THE DRAWINGS

These and other features of this invention will be more readily understood from the following detailed description of the various aspects of the invention taken in conjunction with the accompanying drawings in which:

FIG. 1 is a block diagram illustrating an exemplary computerized implementation of a system and method according to the present invention.

FIG. 2 is a flow chart illustrating a method or process according to the present invention.

### DETAILED DESCRIPTION

Embodiments of the present invention provide a data package format library that provides a means to load, create and manipulate data from a plurality of different data formats in the data package format. The data package format reduces the need for all the service tools to be able to parse and save to a variety of data formats, and serves the needs currently served by a variety of different file formats. By combining and standardizing on one format, the data package format library eliminates the need to continually write and maintain a variety of file parsers that are currently required and in use in the prior art.

Raw data from the field can come in a variety of formats. In order for the various service tools to be able to handle these formats, one of two approaches can be adopted. The first is to allow all service tools to import from the full set of known formats. This is a maintenance issue when trying to add a new format. The second approach is to first convert all the known file formats into a common file format. This allows the service tools to be written against the known format and allows the parsing code for the other file formats to be collected in one place.

This is the approach that has been adopted in the past and current generation of service tools. Formats such as .pim, .pam, .pac, .ads and .tsd have all served as the lingua franca of the service tools. Each successive generation of file format has built on the previous generation in terms of capabilities and supported file formats. However, the prior art file formats have all concentrated on input side of the various service tools. None of the previous file formats focus on the output of the tools once the data has been imported.

Common File Format to Allow Interoperability Between Tools.

Embodiments of the data package format library allow for the interoperability of a single data file between tools. In the prior art, once data is imported into a tool it is locked into that tool and its proprietary output file format: it is not easily possible to take data from one tool and analyze it in another tool without going back to the source data file, nor is it possible to modify or append to a data set once that data had been loaded into one of the prior art analysis tools. In contrast, the data package format library according to the present invention supports the ability to store data in a standard way that allows for this ‘round tripping’ of data between tools, allowing the various tools to interact in ways which were not previously possible when using the prior art versions of file information.

Data package format library embodiments according to the present invention comprise a variety of data attributes. They can store strongly typed time series information, and time stamp data is stored for each data point. They are able to store both scalar and vector time series, meta-data about the information in the package, and application-specific information. They may define types of equipment that can be consumed by the client applications. Equipment model information is independent of the application-specific information stored in the file, which enables the ability to create generic tools to view and manipulate said information. They may also store the definitions of the equipment types as well as instances of those types, which makes the file format a fully self-contained entity with no dependence on outside definitions.

Data package format library embodiments also comprise a variety of structure attributes. Support is provided for both writing data and reading data from the file; it is not optimized for reading or writing at the expense of the other. The file format supports the ability to stream data from disk rather than holding the entire file in memory, which supports files that are larger than can fit in memory. Multiple sets of data may be supported in a single file. Files may be hand-edited in the field, and thus in contrast to pure binary file formats corrupted files may be fixed in the field. The structure may also be easily extended with new information in the future without completely breaking existing implementations.

Data Package Overview.

Embodiments of the data package according to the present invention are abstractions of underlying file storage mechanisms. An associated library provides access to the information contained in this file. The data package object is a base object within embodiments of the data package format library. Generally all access to other objects is done through an instance of a data package. The data package represents a collection of information including time series data, equipment models, events and application specific information related to the time series data.

Embodiments of the present invention described herein show by example various ways in which client applications can interact with the information contained in the file. In one example the underlying file is a zip file with different sections for each of the types of information stored in the package. However, other embodiments do not use zip file or associated folders and files structures. More particularly, the embodiments described herein are illustrative but not exhaustive examples of the present invention and other variations will be apparent to one skilled in the art.

Public Interfaces.

The following is one example of public interfaces of a DataPackage according to the present invention:

```
Public Shared Function Create( ) As DataPackage
Public Shared Function Create(ByVal FileName As String) As
DataPackage
Public Shared Function Load(ByVal FileName As String, _{—}
        ByVal FileAccess As IO.FileAccess) As DataPackage
Public ReadOnly Property FileAccess As IO.FileAccess
Public ReadOnly Property FileName As String
Public ReadOnly Property ShortFileName As String
Public ReadOnly Property WorkingFileName( ) As String
Public ReadOnly Property TimeSeriesDefinitions As
TimeSeriesDefinitionCollection
Public ReadOnly Property PackageProperties As
PackagePropertyCollection
Public ReadOnly Property ApplicationDataDefinitions _{—}
        As ApplicationDataDefinitionCollection
Public ReadOnly Property Events As EventCollection
Public ReadOnly Property EquipmentModelDefinitions( ) As
EMItemDefinitionCollection
Public ReadOnly Property EquipmentModel As EMItemCollection
Public Function Save( ) As Boolean
Public Function SaveAs(ByVal newFileName As String) As Boolean
Public Sub Dispose( )
```

### Usage Examples

The following is one example of creating a new file and saving it in a named location according to the present invention:

```
‘Create new file
Dim newPackage As DataPackage = DataPackage.Create( )
        ‘-------
        ‘Do something
        ‘-------
‘Save file
newPackage.SaveAs(“C:\Temp\MyFile.dpf”)
‘Close file
newPackage.Dispose( )
```

The following is one example of creating a named file and saving it according to the present invention:

```
        ‘Create new file
        Dim newPackage As DataPackage =
DataPackage.Create(“C:\Temp\MyFile.dpf”)
                ‘-------
                ‘Do something
                ‘-------
        ‘Save file
        newPackage.Save( )
        ‘Close file
        newPackage.Dispose( )
```

The following is one example of load a named file for read only access according to the present invention:

```
        ‘Create new file
        Dim newPackage As DataPackage =
DataPackage.Load(“C:\Temp\MyFile.dpf”, _{—}
                FileAccess.Read)
                ‘-------
                ‘Do something
                ‘-------
        ‘Close file
        newPackage.Dispose( )
```

The following is one example of loading a named file for read/write access according to the present invention:

```
        ‘Create new file
        Dim newPackage As DataPackage =
DataPackage.Load(“C:\Temp\MyFile.dpf”, _{—}
                FileAccess.ReadWrite)
                ‘-------
                ‘Do something
                ‘-------
        ‘Close file
        newPackage.Save( )
        newPackage.Dispose( )
```

Data Package Components.

In one example the data package format consists of six primary components:
a) Time series definition—Used for storing time series data.
b) Package properties—Used to store information about the data package itself.
c) Events—Used to define time periods of interest in the data.
d) Application data—Used by client applications to store other information related to the data.
e) Equipment model definitions—Used to define types for the equipment model.
f) Equipment model—Used to define instances of the equipment model definitions.

### TIME SERIES DEFINITION

The data package format stores time series information as a series of data points and time stamps. For example, an exemplary “ITimeSeriesDefinition” object is used to access time series information within the data package. The time series definition is generally a light weight object which represents information about a particular time series within a package. When the data package is loaded, the definitions for all the time series data in the package are loaded into memory, but wherein the data associated with these time series is not loaded. The actual data is streamed from the disk when the information is accessed through the time series definition object. This allows the data package file to load quickly and to store data in files larger than can be conveniently help in memory.

The time series information within the data package is stored in multiple formats. For speed and accessibility, the data may be stored in a binary format, which may be used when streaming the data from a disk. The data may also be stored in a text based, human-readable format. This representation of the data is not used normally. However, by storing the data in a human-readable format, it allows end users the ability to edit the data if desired using a standard text editor. If the human-readable text file within the data package is edited, the binary files may be automatically regenerated from the text files.

Embodiments of the data package format support both scalars and vectors of the following data types: Boolean, Byte, Char, Date, Double, Int16, Int32, Int64, SByte, Single, String, UInt16, UInt32 and UInt64.

Data within the data package is stored as strongly typed data. When retrieving the data, the client application can choose to retrieve the data in either the native type for the data, or as strongly typed data of the client's choosing. The data point object will handle the conversion of the data type from the actual data type to any of the above supported data types.

Examples of public interfaces for the time series component include the following:

ITimeSeriesDefinition:

```
Public Interface ITimeSeriesDefinition
  Inherits IDPComponent
  ReadOnly Property TypeCode As System.TypeCode
  ReadOnly Property VectorSize As Integer
  ReadOnly Property StartDate As DateTime
  ReadOnly Property EndDate As DateTime
  ReadOnly Property DatapointCount As Int32
  ReadOnly Property ID As Guid
  Property Name As String
  Property DeviceTag As String
  Property Description As String
  Function GetEnumerator( ) As IEnumerator(Of IDataPoint)
  Function GetEnumerator(ByVal StartTime As DateTime) _{—}
        As IEnumerator(Of IDataPoint)
  Function GetEnumerator(ByVal StartTime As DateTime, _{—}
        ByVal EndTime As DateTime) As IEnumerator(Of IDataPoint)
  ReadOnly Property Points( ) As IEnumerable(Of IDataPoint)
  ReadOnly Property Points(ByVal StartTime As DateTime) _{—}
        As IEnumerable(Of IDataPoint)
  ReadOnly Property Points(ByVal StartTime As DateTime, _{—}
        ByVal EndTime As DateTime) As IEnumerable(Of IDataPoint)
  Function GetWriter(ByVal Mode As WriteMode) As ITimeSeriesWriter
End Interface
```

IDataPoint:

```
Public Interface IDataPoint
    ReadOnly Property TypeCode As System.TypeCode
    ReadOnly Property TimeStamp As DateTime
    Function Value( ) As Object
    Function Value(Of T)( ) As T
    Function Clone( ) As IDataPoint
End Interface
```

ITimeSeriesWriter:

```
Public Interface ITimeSeriesWriter
    Sub Write(ByVal Points As IEnumerable(Of IDataPoint))
    Sub Write(ByVal Points As IEnumerable(Of IDataPoint), _{—}
            ByVal NewTypeCode As TypeCode,
            ByVal NewVectorSize As Integer)
    Sub Write(ByVal TimeStamps As IList(Of DateTime), _{—}
            ByVal Values As IEnumerable(Of Object))
    Sub Write(ByVal TimeStamps As IList(Of DateTime), _{—}
            ByVal Values As IEnumerable(Of Object), _{—}
            ByVal NewTypeCode As TypeCode,
            ByVal NewVectorSize As Integer)
End Interface
```

The following are examples of how the time series data within the data package is used in actual practice.

Creating new scalar time series in data package:

```
‘Create new file
Dim newPackage As DataPackage = DataPackage.Create( )
‘Generate data
Dim values as New List(of Double)
Dim timeStamps as New List(of DateTime)
Dim r as New Random
Dim startTime as Date = Now
For i as Integer = 0 to 10
      values.Add(R.NextDouble)
      timeStamps.Add(startTime.AddSeconds(i))
Next
‘Create new time series definition
Dim def As ITimeSeriesDefinition = _{—}
      newPackage.TimeSeriesDefinitions.CreateNew(“Scalar series”, _{—}
      TypeCode.Double, 0)
def.GetWriter(WriteMode.Overwrite).Write(timeStamps, values)
‘Save file
newPackage.SaveAs(“C:\Temp\MyFile.dpf”)
```

Creating new vector time series in data package:

```
‘Create new file
Dim newPackage As DataPackage = DataPackage.Create( )
‘Generate data
Dim values as New List(of List(of Double))
Dim timeStamps as New List(of DateTime)
Dim r as New Random
Dim vectorSize as Integer = 300
Dim startTime as Date = Now
For i as Integer = 0 to 10
      Dim vector as New List(of Double)
      For j as Integer = 0 to vectorSize −1
            Vector.Add(R.NextDouble)
      Next
      values.Add(vector)
      timeStamps.Add(startTime.AddSeconds(i))
Next
‘Create new time series definition
Dim def As ITimeSeriesDefinition = _{—}
      newPackage.TimeSeriesDefinitions.CreateNew(“Vector series”, _{—}
      TypeCode.Double, vectorSize)
def.GetWriter(WriteMode.Overwrite).Write(timeStamps, values)
‘Save file
newPackage.SaveAs(“C:\Temp\MyFile.dpf”)
```

Reading time series values as their native types:

```
    ‘Open file
    Dim newPackage As DataPackage =
DataPackage.Load(“C:\Temp\MyFile.dpf” _{—}
        FileAccess.Read)
    ‘Read all time series
    For each def as ITimeSeriesDefinition in
newPackage.TimeSeriesDefinitions
        Dim values as List(of Object)
        Dim timeStamps as List(of DateTime)
        For each p as IDataPoint in def.Points
            values.Add(p.Value)
            timestamps.Add(p.TimeStamp)
        Next
        ‘-------
        ‘Do whatever you like with the data here
        ‘-------
    Next
    ‘Read a named time series
    Dim def as ITimeSeriesDefinition = _{—}
        newPackage.TimeSeriesDefinitions.GetTimeSeries(“Vector
        series”)
    For each p as IDataPoint in def.Points
        ‘-------
        ‘Do whatever you like with the data here
        ‘-------
    Next
```

Reading time series values as a fixed type:

```
    ‘Open file
    Dim newPackage As DataPackage =
DataPackage.Load(“C:\Temp\MyFile.dpf” _{—}
        FileAccess.Read)
    ‘Read all time series as integer values
    For each def as ITimeSeriesDefinition in
newPackage.TimeSeriesDefinitions
        Dim values as List(of Integer)
        Dim timeStamps as List(of DateTime)
        For each p as IDataPoint in def.Points
            values.Add(p.Value(Of Integer))
            timestamps.Add(p.TimeStamp)
        Next
        ‘-------
        ‘Do whatever you like with the data here
        ‘-------
    Next
    ‘Read the vector series as an array of integers
    Dim def as ITimeSeriesDefinition = _{—}
    newPackage.TimeSeriesDefinitions.GetTimeSeries(“Vector
    series”)
For each p as IDataPoint in def.Points
    Dim value( ) as Integer
    Dim timeStamp as Date
    value = p.Value(Of Integer( ))
    timeStamp = p.TimeStamp
    ‘-------
    ‘Do whatever you like with the data here
    ‘-------
Next
```

Appending data to an existing time series:

```
      ‘Open file
      Dim newPackage As DataPackage =
DataPackage.Load(“C:\Temp\MyFile.dpf”, _{—}
                  FileAccess.ReadWrite)
      ‘Generate data
      Dim newValues as New List(of Double)
      Dim newTimeStamps as New List(of DateTime)
      Dim r as New Random
      Dim startTime as Date = Now
      For i as Integer = 0 to 10
            newValues.Add(R.NextDouble)
            newTimeStamps.Add(startTime.AddSeconds(i))
      Next
      ‘Get time series definition
      Dim def As ITimeSeriesDefinition = _{—}
            newPackage.TimeSeriesDefinitions.GetTimeSeries(“Scalar
          series”)
      def.GetWriter(WriteMode.Append).Write(newTimeStamps,
      newValues)
```

Deleting a time series from a package:

```
    ‘Open file
    Dim newPackage As DataPackage =
DataPackage.Load(“C:\Temp\MyFile.dpf”, _{—}
              FileAccess.ReadWrite)
    ‘Get time series definition
    Dim def As ITimeSeriesDefinition = _{—}
        newPackage.TimeSeriesDefinitions.GetTimeSeries(“Scalar
      series”)
    newPackage.TimeSeriesDefinitions.Remove(def)
    ‘Save file
    newPackage.Save( )
```

Package Properties.

The data package format supports storage of information regarding the data package itself. In one example the properties of the package itself are represented by the “IPackageProperty” interface. A property of the data package is a strongly typed value associated with a name. These named properties can be grouped together in categories for easier viewing. For example, a category of properties might represent information regarding the collection of the data within the package. The values within that category might be the name of the person collecting the data, the sample rate, the type of system from which it was pulled, and the interface that was used to gather the data. Another category might represent information about the customer and site at which the information was collected.

The package properties represent extra information about the data package and are generally used for informational purposes only. Any data required by an application should generally be stored in the application data section of the package. Package properties are subject to change and should not generally be relied upon for any particular type of information.

The following is an example of a “ITimeSeriesWriter” public interface according to the present invention:

```
Public Interface IPackageProperty
    Inherits IDPComponent
    ReadOnly Property Category As String
    ReadOnly Property Name As String
    ReadOnly Property Description As String
    ReadOnly Property TypeCode As TypeCode
    Property Value As Object
End Interface
```

The following are public interface usage examples.

Creating new package properties in data package:

```
      ‘Create new file
      Dim newPackage As DataPackage = DataPackage.Create( )
      ‘Generate package properties
      newPackage.PackageProperties.CreateNew(“General”,
“CollectionName”, _{—}
            “The name of the person collecting the data” ,
            “Tim Mast”, _{—}
            TypeCode.String)
      newPackage.PackageProperties.CreateNew(“General”,
      “SampleRate”, _{—}
            “The sample rate of the data in seconds” , CInt(5), _{—}
            TypeCode.Integer)
      newPackage.PackageProperties.CreateNew(“General”,
      “SystemType”, _{—}
            “The type of system from which the data was pulled” ,
    “800xA”, _{—}
            TypeCode.String)
newPackage.PackageProperties.CreateNew(“Customer”,
“CustomerName”, _{—}
      “The name of the customer” , “Bob's Meatpacking Inc.”, _{—}
      TypeCode.String)
newPackage.PackageProperties.CreateNew(“Customer”, “Location”, _{—}
      “The location of the customer” , “Atlanta, GA”, _{—}
      TypeCode.String)
‘Save file
newPackage.SaveAs(“C:\Temp\TestFile.dpf”)
```

Reading package properties in data package:

```
      ‘Open file
      Dim newPackage As DataPackage =
DataPackage.Load(“C:\Temp\MyFile.dpf”, _{—}
                  FileAccess.ReadWrite)
      ‘Read package properties
      For each p as IPackageProperty in newPackage.PackageProperties
            Debug.WriteLine(p.Category)
            Debug.WriteLine(p.Name)
            Debug.WriteLine(p.Description)
            Debug.WriteLine(p.Value)
            Debug.WriteLine(p.TypeCode)
            ‘-------
            ‘Do whatever you like with the data here
            ‘-------
      Next
```

Events.

The data package format stores time information regarding things that have happened within the data as “happenings” or “events.” Each event consists of an event type and a start and stop time for that event. These events are lightweight markers that indicate areas of interest within the data.

The event type is generally a string used to represent the type of occurrence that the event represents. For example, one event type might represent when the production line is changing from the production of one type of material to another. Another event type might represent when a particular control was being modified.

The events do not generally have any information associated with them other than the times related to the event. Any additional information should generally be stored in the application data section by the application or client making use of the events.

One example of an event public interfaces is the following “IEvent”:

Public Interface IEvent

Inherits IDPComponent
ReadOnly Property EventType As String
ReadOnly Property StartTime As DateTime
ReadOnly Property StopTime As DateTime

End Interface

Usage examples for events include the following.

Creating new events in data package:

```
    ‘Create new file
    Dim newPackage As DataPackage = DataPackage.Create( )
    ‘Generate events
    Dim startTime as DateTime = Now
    For i as Integer = 0 to 4
        newPackage.Events.CreateNew(“GradeChange”,
startTime.AddHours(i), _{—}
            startTime.AddHours(i).AddMinutes(45))
    Next
    ‘Save file
    newPackage.SaveAs(“C:\Temp\TestEventFile.dpf”)
```

Reading events in data package:

```
‘Open file
Dim newPackage As DataPackage =
    DataPackage.Load(“C:\Temp\TestEventFile.dpf”,
FileAccess.ReadWrite)
‘Read events
For each e as IEvent in newPackage.Events
    Debug.WriteLine(e.EventType)
    Debug.WriteLine(e.StartTime)
    Debug.WriteLine(e.StopTime)
    ‘-------
    ‘Do whatever you like with the event data here
    ‘-------
Next
```

Application Data.

The data package format allows for the ability for client applications to save application specific data into the package. When loaded, the data package loads a collection of light weight objects which represent the application specific information in the package. These objects can then be called to get access to a stream which represents the data in the file. Applications can store as many individual files in the data package as required. These files are accessed as streams and have no requirements as to what type or kind of data is stored in the files.

One example of an application data public interface is the following “IApplicationDataDefinition”:

Public Interface IApplicationDataDefinition

Inherits IDPComponent
ReadOnlyProperty ApplicationName As String
ReadOnlyProperty FileName As String
ReadOnlyProperty GetStream( ) As Stream

End Interface

Usage examples of the application data component include the following.

Creating new application data in data package:

```
    ‘Create new file
    Dim newPackage As DataPackage = DataPackage.Create( )
    ‘Write text file
    Dim textDef As IApplicationDataDefinition =
newPackage.ApplicationDataDefinitions.CreateNew(“MyApplication”, _{—}
        “ConfigurationTextFile”)
    Dim fileStream as Stream = textDef.GetStream
    Using writer as new StreamWriter
        writer.WriteLine(“This is line 1”)
        writer.WriteLine(“This is line 2”)
    End Using
    ‘Write binary file
    Dim binDef As IApplicationDataDefinition =
newPackage.ApplicationDataDefinitions.CreateNew(“MyApplication”, _{—}
        “ConfigurationBinaryfile”)
    Using s as Stream = binDef.GetStream
        Dim dataSize as Integer = 200000
        Dim data(dataSize −1) as Byte
        For i as Integer = 0 to dataSize −1
            data(i) = CByte(i Mod 4)
        Next
        s.Write(data,0,dataSize)
    End Using
    ‘Save file
    newPackage.SaveAs(“C:\Temp\TestApplicationFile.dpf”)
```

Reading application data in data package:

```
‘Open file
Dim newPackage As DataPackage =
    DataPackage.Load(“C:\Temp\TestApplicationFile.dpf”, _{—}
    FileAccess.Read)
‘Read application data
Dim def as IApplicationDataDefinition = _{—}
    newPackage.ApplicationDataDefinitions.GetApplicationDefinition
    ( _{—}
    (“MyApplication”, “ConfigurationTextFile”)
Using s as Stream = def.GetStream
      ‘-------
      ‘Do whatever you like with the stream data here
      ‘-------
End Using
```

### EQUIPMENT MODEL DEFINITIONS

The data package format supports the ability to store equipment model information in the same package as the other types of information listed here. The equipment model information may be broken up into two parts. The first is the definition of equipment model definitions. These definitions define specific types of equipment that can be found in a system. The equipment model section of the package is then used to define instances of these equipment model types. Equipment model item definitions generally comprise a name and a set of properties associated with that item. Each property definition comprises a name and a category. Properties can be of three different types. In one example a TimeSeries type indicates that this property is tied to a time series, a Value type indicates that this property can be a scalar of the named type, and an Enum type indicates that a property can be one of the values named in the enumeration.

Equipment model definition public interfaces examples include the following:

IEMItemDefinition:

Public Interface IEMItemDefinition

Inherits IDPComponent
ReadOnly Property Name As String
ReadOnly Property ID As Guid
ReadOnly Property Properties As EMPropertyDefinitionCollection

End Interface

IEMPropertyDefinition:

Public Interface IEMPropertyDefinition

Inherits IDPComponent
ReadOnly Property Category As String
ReadOnly Property Name As String
ReadOnly Property ID As Guid
ReadOnly Property PropertyType As EMPropertyType
ReadOnly Property TypeCode As System.TypeCode
ReadOnly Property EnumAllowableValues As IDictionary(Of String,
Integer)

End Interface

EMPropertyType:

```
Public Enum EMPropertyType
    TimeSeries = 0
    Value = 1
    [Enum] = 2
End Enum
```

Equipment model definition usage examples include the following:

Defining equipment model definitions in data package:

```
‘Create new file
Dim newPackage As DataPackage = DataPackage.Create( )
‘Create example equipment model definition
Dim def As IEMItemDefinition =
    newPackage.EquipmentModelDefinitions.-
CreateNew(“LoopScan_Loop”)
‘Create value type properties on the definition
def.Properties.CreateNewValueProperty(“General”, “LoopName”, _{—}
    TypeCode.String)
def.Properties.CreateNewValueProperty(“General”, “ProcessArea”, _{—}
    TypeCode.String)
def.Properties.CreateNewValueProperty(“General”, “LoopDescription”, _{—}
    TypeCode.String)
‘Create enum type properties on the definition
def.Properties.CreateNewEnumProperty(“General”, “ControllerType”, _{—}
    New Dictionary(Of String, Integer) From
```

```
{{“Feedback”, 0},
  {“Cascade(Master)”, 1},
  {“Cascade(Slave)”, 2},
  {“Ratio”, 3},
  {“Min/Max”, 4}
  })
```

def.Properties.CreateNewEnumProperty(“General”, “ProcessType”, _{—}
New Dictionary(Of String, Integer) From

```
{{“Flow (liquid)”, 0},
  {“Flow (other)”, 1},
  {“Temperature”, 2}
  })
```

```
‘Create time series type properties on the definition
def.Properties.CreateNewTimeSeriesProperty(“Signals”, “SPTag”, _{—}
    TypeCode.Double)
def.Properties.CreateNewTimeSeriesProperty(“Signals”, “MVTag”, _{—}
    TypeCode.Double)
def.Properties.CreateNewTimeSeriesProperty(“Signals”, “OUTTag”, _{—}
    TypeCode.Double)
def.Properties.CreateNewTimeSeriesProperty(“Signals”, “ModeTag”, _{—}
    TypeCode.Double)
‘Save file
newPackage.SaveAs(“C:\Temp\TestEMDefFile.dpf”)
```

Reading equipment model definitions in data package:

```
    ‘Open file
    Dim newPackage As DataPackage =
        DataPackage.Load(“C:\Temp\ TestEMDefFile.dpf”, _{—}
        FileAccess.Read)
    ‘Read equipment model definitions
    For each emd as IEMItemDefinition in
newPackage.EquipmentModelDefinitions
        Debug.WriteLine(emd.Name)
        For each emp as IEMPropertyDefinition
            Debug.WriteLine(emp.Category)
            Debug.WriteLine(emp.Name)
            Debug.WriteLine(emp.PropertyType)
        Next
        ‘-------
        ‘Do whatever you like with the item and property definitions
here
        ‘-------
    Next
```

Equipment Model.

The data package format has a dedicated section for storing instances of the equipment model definitions defined in the equipment model definition section. The instances of the equipment model items define the structure of the equipment at a certain location. For example, assume that in the equipment model definition section there is a definition for a control loop. In the equipment model section, there would be multiple instances of this control loop type representing the many control loops at a certain plant.

The items in the equipment model may depend heavily on the definitions of the equipment model in the previous section. It is generally not possible to define an instance of the equipment model without first defining the definition and properties of the equipment model in the previous section.

Each instance of the equipment model is defined by a name and a collection of properties. The properties associated with a particular equipment model item are determined by the definition of the equipment model and its associated properties.

Equipment model public interfaces examples include the following:

IEMItem:

Public Interface IEMItem

Inherits IDPComponent
ReadOnly Property Name As String
ReadOnly Property Definition As IEMItemDefinition
ReadOnly Property Properties As EMPropertyCollection
ReadOnly Property Children As EMItemCollection

End Interface

IEMProperty:

```
Public Interface IEMProperty
    Inherits IDPComponent
    ReadOnly Property Definition As IEMPropertyDefinition
    Property Value( ) As Object
End Interface
```

Equipment model usage examples include the following:
Defining equipment model in data package:

```
‘Read equipment model definitions defined in previous section
Dim newPackage As DataPackage =
    DataPackage.Load(“C:\Temp\TestEMDefFile.dpf”,
    FileAccess.ReadWrite)
‘Create example equipment model item
Dim def as IEMItemDefinition = _{—}
    newPackage.EquipmentModelDefinitions.GetItemDefinition( _{—}
    “LoopScan_Loop”)
Dim item As IEMItem =
    newPackage.EquipmentModel.CreateNew(“Loop 1”, def)
‘Set values on value properties
item.Property.GetProperty(“General”, “LoopName”).Value = _{—}
    “Loop 1”
item.Property.GetProperty(“General”, “ProcessArea”).Value = _{—}
    “Cracking tower 1”
item.Property.GetProperty(“General”, “LoopDescription”).Value = _{—}
    “Primary coolant flow to cracking tower 1”
‘Set values on enum properties
item.Property.GetProperty(“General”, “ControllerType”) = 0
item.Property.GetProperty(“General”, “ProcessType”) = 0
‘Set values on time series properties
item.Property.GetProperty(“Signals”, “SPTag”) = _{—}
    newPackage.TimeSeriesDefinitions.GetTimeSeries( _{—}
    “CT1.Coolant.PC175.SP”
item.Property.GetProperty(“Signals”, “MVTag”) = _{—}
    newPackage.TimeSeriesDefinitions.GetTimeSeries( _{—}
    “CT1.Coolant.PC175.MV”
item.Property.GetProperty(“Signals”, “OUTTag”) = _{—}
    newPackage.TimeSeriesDefinitions.GetTimeSeries( _{—}
    “CT1.Coolant.PC175.OUT”
item.Property.GetProperty(“Signals”, “ModeTag”) = _{—}
    newPackage.TimeSeriesDefinitions.GetTimeSeries( _{—}
    “CT1.Coolant.PC175.Mode”
‘Save file
newPackage.Save( )
```

Reading equipment model in data package:

```
‘Open file
Dim newPackage As DataPackage =
    DataPackage.Load(“C:\Temp\ TestEMDefFile.dpf”, _{—}
    FileAccess.Read)
‘Read equipment model
For each emi as IEMItem in newPackage.EquipmentModel
    Debug.WriteLine(emi.Name)
    For each emp as IEMProperty
        Debug.WriteLine(emp.Value)
    Next
    ‘-------
    ‘Do whatever you like with the item and property definitions
```

here

‘-------
Next

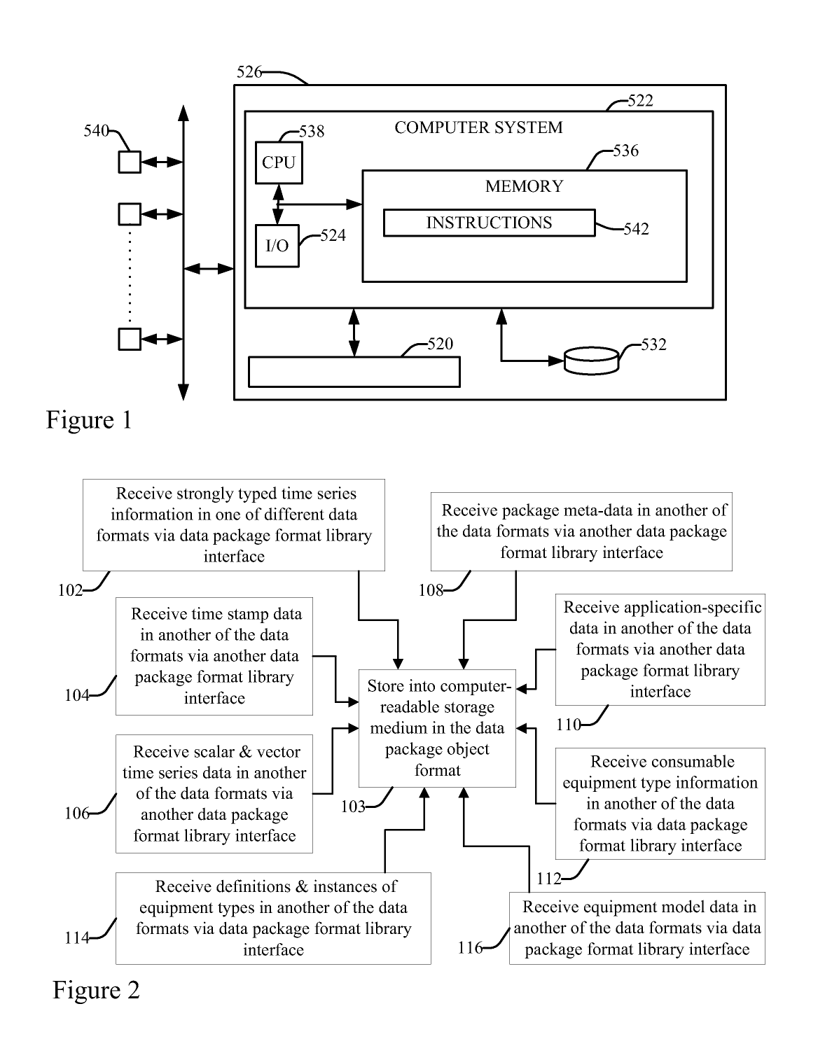

Referring now to FIG. 1, an exemplary computerized implementation of an embodiment of the present invention includes a computer system or other programmable device 522 in communication with data sources 540 (for example, from each of a plurality of different automation system components 540). Instructions 542 reside within computer readable code in a computer readable memory 536, or in a computer readable storage system 532, or other tangible computer readable storage medium that is accessed through a computer network infrastructure 526 by a processing unit (CPU) 538 or an input-output (I/O) 524. Thus, the instructions, when implemented by the processing unit (CPU) 538, cause the processing unit (CPU) 538 to handle data via the data package format library described above.

Embodiments of the present invention may also perform process steps of the invention on a subscription, advertising, and/or fee basis. That is, a service provider could offer to integrate computer-readable program code into the computer system 522 to enable the computer system 522 to handle data via the data package format library described above. The service provider can create, maintain, and support, etc., a computer infrastructure such as the computer system 522, network environment 526, or parts thereof, that perform the process steps of the invention for one or more customers. In return, the service provider can receive payment from the customer(s) under a subscription and/or fee agreement. Services may comprise one or more of: (1) installing program code on a computing device, such as the computer device 522, from a tangible computer-readable medium device 520 or 532; (2) adding one or more computing devices to a computer infrastructure; and (3) incorporating and/or modifying one or more existing systems of the computer infrastructure to enable the computer infrastructure to perform the process steps of the invention.

The terminology used herein is for describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising” when used in this specification, specify the presence of stated features, integers, steps, operations, elements, and/or components, but do not preclude the presence or addition of one or more other features, integers, steps, operations, elements, components, and/or groups thereof. Certain examples and elements described in the present specification, including in the claims and as illustrated in the Figures, may be distinguished or otherwise identified from others by unique adjectives (e.g., a “first” element distinguished from another “second” or “third” of a plurality of elements, a “primary” distinguished from a “secondary” one or “another” item, etc.) Such identifying adjectives are generally used to reduce confusion or uncertainty, and are not to be construed to limit the claims to any specific illustrated element or embodiment, or to imply any precedence, ordering or ranking of any claim elements, limitations or process steps.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in a baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including, but not limited to, wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In view of the above, FIG. 2 illustrates a method or process according to the present invention for storing and providing, via a plurality of different interfaces of a data package format library, a data package object as a base object that represents a collection of information from a plurality of different data format inputs by relating application-specific information to the time series data. Thus, at 102 a strongly typed time series information data input within a first one of a plurality of different data formats is received via an interface of the data package format library, and stored at 103 into a tangible computer-readable storage medium in the data package object format.

At 104, a time stamp data input is received for each data point in another of the different data formats via an interface of the data package format library and stored at 103 into the storage medium in the data package object format. At 106 scalar and vector time series data is received in one of the different data formats via an interface of the data package format library and stored at 103 into the computer-readable storage medium in the data package object format. At 108 meta-data about information in the package is received in one of the different data formats via an interface of the data package format library, and at 103 stored into the storage medium in the data package object format. At 110 application-specific information is received via an interface of the data package format library in one of the different data formats, and at 103 stored into the computer-readable storage medium in the data package object format.

At 112 types of equipment that can be consumed by client applications and received in one of the plurality of different data formats are defined, received via an interface of the data package format library and stored into the computer-readable storage medium in the data package object format. At 114 definitions and instances of equipment types received in one of the different data formats via an interface of the data package format library are stored into the computer-readable storage medium in the data package object format. At 116 equipment model information that is independent of the stored application-specific information is received in one of the different data formats via an interface of the data package format library, and stored into the computer-readable storage medium in the data package object format.

What is claimed is:

1. A system, comprising:
a processing unit in communication with a computer-readable memory and a tangible computer-readable storage medium;
wherein the processing unit, when executing program instructions stored on the tangible computer-readable storage medium via the computer readable memory:
provides a data package format library to load, create and manipulate data from a plurality of different data formats into a format of a data package object, wherein the data package object is a base object that represents a collection of information comprising time series data, equipment models, events, and relates the application-specific information to the time series data;
stores strongly typed time series information from a data input received in one of the plurality of different data formats via an interface of the data package format library into the computer-readable storage medium in the data package object format;
stores time stamp data for each data point received in one of the plurality of different data formats via an interface of the data package format library into the computer-readable storage medium in the data package object format; and
stores scalar and vector time series information received in one of the plurality of different data formats via an interface of the data package format library into the computer-readable storage medium in the data package object format.

2. The system of claim 1, wherein the processing unit further:
stores meta-data about information in the package received in one of the plurality of different data formats via an interface of the data package format library into the computer-readable storage medium in the data package object format;
stores application-specific information received in one of the plurality of different data formats via an interface of the data package format library into the computer-readable storage medium in the data package object format;
defines types of equipment that can be consumed by client applications and received in one of the plurality of different data formats via an interface of the data package format library into the computer-readable storage medium in the data package object format;
stores definitions and instances of equipment types received in one of the plurality of different data formats via an interface of the data package format library into the computer-readable storage medium in the data package object format; and
stores equipment model information received in one of the plurality of different data formats via an interface of the data package format library into the computer-readable storage medium in the data package object format and independent of the stored application-specific information.

3. The system of claim 2, wherein the processing unit, via an interface of the data package format library, further:
supports both writing data and reading data from a file stored in the tangible computer-readable storage medium;
supports streaming data from the tangible computer-readable storage medium for stored files that are larger than can fit in the tangible computer-readable storage medium;
supports multiple sets of data in a single file; and
enables files stored in the tangible computer-readable storage medium to be hand-edited.

4. The system of claim 3, wherein the data package format comprises:
a time series definition component that is used for storing time series data;
a package properties component that is used to store information about the data package;
an events component that is used to define time periods of interest in the data;
an application data component that is used by client applications to store other information related to the data;
an equipment model definitions component that is used to define types for the equipment model; and
an equipment model component that is used to define instances of the equipment model definitions.

5. The system of claim 4, wherein the processing unit, via an interface of the data package format library, further:
uses the data package format to stores time series information as a series of data points and time stamps; and
loads the definitions for all the time series data in the package into the computer-readable memory when the data package is loaded, without loading data associated with the time series;
wherein the time series information is stored within the data package in multiple formats, and the time series definition is a light weight object which represents information about a particular time series within a package.

6. The system of claim 5, wherein the processing unit, via an interface of the data package format library, further:
stores data within the data package as strongly typed data; and
enables a client application retrieving the stored data to choose to retrieve the data in either a native type for the data or as the strongly typed data.

7. The system of claim 6, wherein the processing unit, via an interface of the data package format library, uses the data package format to store event data comprising time information regarding events that have happened within the data, and wherein the event data is a lightweight marker comprising an event type and start and stop times for that event.

8. The system of claim 7, wherein the processing unit, via an interface of the data package format library, loads the data package by loading a collection of light weight objects which each represent the application-specific information in the package.

9. The system of claim 8, wherein the equipment model information comprises:
an equipment model definition that defines specific types of equipment that can be found in a system and is used to define instances of equipment model types; and
an equipment model item that comprises a name and a category and a set of properties associated with each item.

10. The system of claim 9, wherein the processing unit, via an interface of the data package format library, further:
defines each instance of the equipment model by a name and a collection of properties; and
determines the properties associated with a particular equipment model item by the definition of the equipment model and its associated properties.

11. An article of manufacture, comprising:
a computer-readable tangible storage medium having computer-readable program code embodied therewith, the computer-readable program code comprising instructions that, when executed by a computer processing unit, cause the computer processing unit to:
provide a data package format library to load, create and manipulate data from a plurality of different data formats in a data package format of the data package format library;
wherein the processing unit thereby:
stores strongly typed time series information;
stores time stamp data for each data point;
stores both scalar and vector time series;
stores meta-data about information in the package;
stores application-specific information;
defines types of equipment that can be consumed by client applications;
stores definitions and instances of equipment types; and
stores equipment model information independent of the stored application-specific information.

12. The article of manufacture of claim 11, wherein the data package format library data package format:
supports both writing data and reading data from a stored file;
supports streaming data from the storage medium for stored files that are larger than can fit in a memory;
supports multiple sets of data in a single file; and
enables stored files to be hand-edited.

13. The article of manufacture of claim 12, wherein the processing unit, when executing the program code instructions, defines a data package object as a base object that represents a collection of information comprising time series data, equipment models, events, and relates the application-specific information to the time series data.

14. The article of manufacture of claim 13, wherein the data package format comprises:
a time series definition component that is used for storing time series data;
a package properties component that is used to store information about the data package;
an events component that is used to define time periods of interest in the data;
an application data component that is used by client applications to store other information related to the data;
an equipment model definitions component that is used to define types for the equipment model; and
an equipment model component that is used to define instances of the equipment model definitions.

15. The article of manufacture of claim 14, wherein the processing unit, when executing the program code instructions, further:
uses the data package format to stores time series information as a series of data points and time stamps;
loads the definitions for all the time series data in the package into the memory when the data package is loaded, without loading data associated with the time series;
wherein the time series information is stored within the data package in multiple formats, and the time series definition is a light weight object which represents information about a particular time series within a package.

16. A method, comprising:
providing via an interface of a data package format library a data package object as a base object that represents a collection of information from a plurality of different data formats comprising time series data, equipment models, events, and relates the application-specific information to the time series data;
storing strongly typed time series information received in one of the plurality of different data formats via an interface of the data package format library into a computer-readable storage medium in the data package object format;
storing time stamp data for each data point received in one of the plurality of different data formats via an interface of the data package format library into the computer-readable storage medium in the data package object format; and
storing scalar and vector time series received in one of the plurality of different data formats via an interface of the data package format library into the computer-readable storage medium in the data package object format.

17. The method of claim 16, further comprising:
storing meta-data about information in the package received in one of the plurality of different data formats into the tangible computer-readable storage medium in the data package object format via an interface of the data package format library;
storing application-specific information received in one of the plurality of different data formats into the tangible computer-readable storage medium in the data package object format via an interface of the data package format library;
defining types of equipment that can be consumed by client applications and received in one of the plurality of different data formats into the tangible computer-readable storage medium in the data package object format via an interface of the data package format library;
storing definitions and instances of equipment types received in one of the plurality of different data formats into the tangible computer-readable storage medium in the data package object format via an interface of the data package format library; and
storing equipment model information received in one of the plurality of different data formats into the tangible computer-readable storage medium in the data package object format via an interface of the data package format library and independent of the stored application-specific information.

18. The method of claim 17, further comprising:
using the data package format to stores time series information as a series of data points and time stamps; and
loading the definitions for all the time series data in the package into a computer-readable memory when the data package is loaded, without loading data associated with the time series;
wherein the time series information is stored within the data package in multiple formats, and the time series definition is a light weight object which represents information about a particular time series within a package.

19. The method of claim 18, further comprising:
storing data within the data package as strongly typed data; and
enabling a client application retrieving the stored data to choose to retrieve the data in either a native type for the data or as the strongly typed data.

20. The method of claim 19, further comprising:
using the data package format to store event data comprising time information regarding events that have happened within the data, wherein the event data is a lightweight marker comprising an event type and start and stop times for that event;
loading the data package by loading a collection of light weight objects which each represent the application-specific information in the package;
defining specific types of equipment that can be found in a system;
defining each instance of an equipment model by a name and a collection of properties; and
determining properties associated with a particular equipment model item by the defined equipment model and its associated properties.
